(19) United States
(12) Patent Application Publication
(10) Pub. No.: US 2016/0052513 A1
(43) Pub. Date: Feb. 25, 2016

(54) TRAVEL ASSISTANCE APPARATUS AND TRAVEL ASSISTANCE METHOD

(71) Applicant: TOYOTA JIDOSHA KABUSHIKI KAISHA, Aichi (JP)

(72) Inventor: Masatsugu ISHIBA, Gotenba-shi, Shizuoka (JP)

(73) Assignee: TOYOTA JIDOSHA KABUSHIKI KAISHA, Toyota-shi, Aichi (JP)

(21) Appl. No.: 14/780,696

(22) PCT Filed: Apr. 4, 2013
(86) PCT No.: PCT/JP2013/060334

§ 371 Date: Sep. 28, 2015

(51) Int. Cl. B60W 30/02

(52) U.S. Cl. CPC B60W 30/02

(57) ABSTRACT

A travel assistance apparatus includes aerodynamic devices that execute a travel assistance for stabilizing a behavior of a vehicle and a calculation apparatus for controlling the aerodynamic devices in response to a disturbance to the behavior of the vehicle caused by an airflow around the vehicle, the calculation apparatus controls the aerodynamic devices in response to the disturbance in an unsteady state in which the disturbance is unsteady between two steady states in which the disturbances caused by the airflow are steady.

### TECHNICAL FIELD

The present invention relates to a travel assistance apparatus and a travel assistance method for stabilizing a behavior of a vehicle.

### BACKGROUND ART

A travel assistance apparatus for stabilizing a behavior of a vehicle is proposed. For example, in Patent Literature 1, an apparatus is disclosed, in which a position of a vehicle is specified by a global positioning system (GPS), a state of an airflow is predicted for each specified position, and the airflow around the vehicle is controlled by a movable front spoiler or a movable rear spoiler according to the predicted state of the airflow.

### CITATION LIST

### Patent Literature

[Patent Literature 1] Japanese Unexamined Patent Application Publication No. 10-119833

### SUMMARY OF INVENTION

### Technical Problem

However, further improvement in the accuracy of the stabilization of the behavior of the vehicle against the airflow is desired.

An object of an embodiment of the present invention is to provide a travel assistance apparatus and a travel assistance method in which the accuracy of control for stabilizing a behavior of the vehicle can be improved.

### Solution to Problem

An aspect of the present invention provides a travel assistance apparatus including a travel assistance unit configured to execute a travel assistance for stabilizing a behavior of a vehicle; and a control unit configured to control the travel assistance unit in response to a disturbance to the behavior of the vehicle caused by an airflow around the vehicle. The control unit is configured to control the travel assistance unit by an amount of operation that varies in response to the disturbance.

According to this configuration, the travel assistance apparatus includes a travel assistance unit configured to execute a travel assistance for stabilizing a behavior of a vehicle; and a control unit configured to control the travel assistance unit in response to a disturbance to the behavior of the vehicle caused by an airflow around the vehicle, the control unit controls the travel assistance unit by an amount of operation that varies in response to the disturbance. With this reason, therefore, for example, even in a case where the vehicle moves from a region where there is no crosswind such as in a tunnel to a region where there is a crosswind such as outside the tunnel, and then, the strength of the airflow around the vehicle suddenly and largely changes, and thus, the disturbance of the force in the lateral direction of the vehicle or the yawing moment suddenly and largely changes, it is possible to appropriately cope with such a disturbance in an unsteady state, compared to in the control by a constant amount of operation in the system in the related art. Therefore, it is possible to improve the accuracy of control for stabilizing the behavior of the vehicle.

In addition, an aspect of the present invention provides a travel assistance apparatus including a travel assistance unit configured to execute a travel assistance for stabilizing a behavior of a vehicle; and a control unit configured to control the travel assistance unit in response to a disturbance to the behavior of the vehicle caused by an airflow around the vehicle. The control unit is configured to control the travel assistance unit in response to the disturbance in an unsteady state in which the disturbance is unsteady between a first steady state in which the disturbance caused by the airflow is steady and a second steady state in which the disturbance caused by the airflow is steady after the first steady state.

According to this configuration, the travel assistance apparatus includes a travel assistance unit configured to execute a travel assistance for stabilizing a behavior of a vehicle; and a control unit configured to control the travel assistance unit in response to a disturbance to the behavior of the vehicle caused by an airflow around the vehicle, the control unit controls the travel assistance unit in response to the disturbance in an unsteady state in which the disturbance is unsteady between a first steady state in which the disturbance caused by the airflow is steady and a second steady state in which the disturbance caused by the airflow is steady after the first steady state. Therefore, for example, even in a case where the vehicle moves from a region where there is no crosswind such as in a tunnel to a region where there is a crosswind such as outside the tunnel, and then, the strength of the airflow around the vehicle suddenly and largely changes, and thus, the disturbance of the force in the lateral direction of the vehicle or the yawing moment suddenly and largely changes, the travel assistance unit is controlled in response to such a transient disturbance in an unsteady state. Therefore, it is possible to improve the accuracy of control for stabilizing the behavior of the vehicle.

In this case, the control unit can predict the disturbance in the unsteady state and control the travel assistance unit in response to the predicted disturbance in the unsteady state.

According to this configuration, the control unit predicts the disturbance in the unsteady state and controls the travel assistance unit in response to the predicted disturbance in the unsteady state. For this reason, for example, before the vehicle moves from the region where there is no crosswind such as in the tunnel to the region where there is the crosswind such as outside the tunnel, it is possible to predict the sudden change of the disturbance caused by the airflow.

In addition, the control unit can control the travel assistance unit by an amount of operation that varies in response to the disturbance in the unsteady state.

According to this configuration, the control unit controls the travel assistance unit by an amount of operation that varies in response to the disturbance in the unsteady state. For this reason, it is rather possible to appropriately cope with the disturbance in the unsteady state compared to the control by the constant amount of operation in the system in the related art.

In addition, the control unit can control the travel assistance unit in response to at least any of the disturbance in the unsteady state when the vehicle enters a weak wind region where the disturbance caused by the airflow is small to a strong wind region where the disturbance caused by the airflow is greater than that in the weak wind region and the disturbance in the unsteady state when the vehicle enters from a strong wind region to a weak wind region.

According to this configuration, the control unit controls the travel stabilization unit in response to at least any of the disturbance in the unsteady state when the vehicle enters a weak wind region where the disturbance caused by the airflow is small to a strong wind region where the disturbance caused by the airflow is greater than that in the weak wind region and the disturbance in the unsteady state when the vehicle enters from the strong wind region to the weak wind region. In this way, for example, it is possible to cope with the case where the vehicle moves from the region where there is no crosswind such as in the tunnel to the region where there is a strong crosswind such as on a bridge outside the tunnel, or on the contrary, the case where the vehicle moves from the region where there is a strong crosswind such as on the bridge to the region where there is no crosswind such as in the tunnel.

In this case, in the strong wind region, the disturbance caused by the airflow from a lateral direction of the vehicle can be greater than that in the weak wind region.

According to this configuration, in the strong wind region, the disturbance caused by the airflow from a lateral direction of the vehicle is greater than that in the weak wind region. For this reason, the control unit can cope with the case where the disturbance caused by the airflow from the lateral direction of the vehicle which influences the straight travelling of the vehicle. Therefore, it is possible to improve the accuracy of stabilizing the straight travelling of the vehicle.

In addition, the disturbance in the first steady state can be smaller than the disturbance in the second steady state.

According to this configuration, the disturbance in the first steady state is smaller than the disturbance in the second steady state. In this way, for example, it is possible to cope with the disturbance in the unsteady state that is generated in a case where the vehicle moves from the region where there is no crosswind such as in the tunnel to the region where there is the strong crosswind such as on the bridge outside the tunnel.

In addition, the disturbance in the first steady state can be greater than the disturbance in the second steady state.

According to this configuration, the disturbance in the first steady state is greater than the disturbance in the second steady state. In this way, for example, it is possible to cope with the disturbance in the unsteady state that is generated in a case where the vehicle moves from the region where there is the strong crosswind such as on the bridge to the region where there is no crosswind such as in the tunnel.

In addition, the travel assistance unit can execute the travel assistance for stabilizing the behavior of the vehicle in at least any one of the yaw direction, the pitch direction, and the roll direction.

According to this configuration, the travel assistance unit executes the travel assistance for stabilizing the behavior of the vehicle in at least any one of the yaw direction, the pitch direction, and the roll direction. Therefore, it is possible to cope with the disturbance in the yaw direction, the pitch direction, and the roll direction of the vehicle which are susceptible to being influenced by the airflow.

In this case, the travel assistance unit can execute the travel assistance for stabilizing the behavior of the vehicle in the yaw direction.

According to this configuration, the travel assistance unit executes the travel assistance for stabilizing the behavior of the vehicle in the yaw direction. Therefore, it is possible to cope with the disturbance in the yaw direction of the vehicle which is susceptible to being influenced by the airflow.

In addition, the travel assistance unit can execute the travel assistance for stabilizing the behavior of the vehicle when travelling straight.

According to this configuration, the travel assistance unit executes the travel assistance for stabilizing the behavior of the vehicle when travelling straight. In this way, it is possible to cope with the situation in which the vehicle travels straight ahead and the influence of the disturbance caused by the airflow is large.

In addition, another aspect of the present invention provides a travel assistance method of controlling a travel assistance unit that executes a travel assistance for stabilizing a behavior of a vehicle in response to a disturbance to the behavior of the vehicle caused by an airflow around the vehicle. The travel assistance unit is controlled by an amount of operation that varies in response to the disturbance.

In addition, still another aspect of the present invention provides a travel assistance method of controlling a travel assistance unit that executes a travel assistance for stabilizing a behavior of a vehicle in response to a disturbance to the behavior of the vehicle caused by an airflow around the vehicle. The travel assistance unit is controlled in response to the disturbance in an unsteady state in which the disturbance is unsteady between a first steady state in which the disturbance caused by the airflow is steady and a second steady state in which the disturbance caused by the airflow is steady after the first steady state.

### Advantageous Effects of Invention

According to a travel assistance apparatus and a travel assistance method in an embodiment of the present invention, it is possible to improve accuracy of control for stabilizing behavior of a vehicle.

### BRIEF DESCRIPTION OF DRAWINGS

FIG. 1 is a block diagram illustrating a configuration of a travel assistance apparatus in an embodiment.

FIG. 2 is a flowchart illustrating a main routine of the travel assistance apparatus in the embodiment.

FIG. 3 is a flowchart illustrating the detailed logic for selecting aerodynamic devices 6A to 6N with respect to a disturbance caused by airflow in FIG. 2.

FIG. 4 is a perspective view illustrating the forces acting on each part of a vehicle.

FIG. 5 is a flowchart illustrating details of the calculation of an aerodynamic force in a crosswind area in FIG. 3.

FIG. 6 is a graph illustrating a yawing moment coefficient Cy with respect to a yaw angle according to an unsteady MAP and a steady MAP.

FIG. 7 is a graph illustrating yaw rates, yawing moment coefficients Cy, and lateral force coefficients Cs in the model in the embodiment and the model in the related art.

FIG. 8-(a) is a plan view illustrating a yaw motion of a travel assistance system in the related art in a wind area and FIG. 8-(b) is a plan view illustrating a yaw motion of a travel assistance system in the embodiment in the wind area.

### DESCRIPTION OF EMBODIMENTS

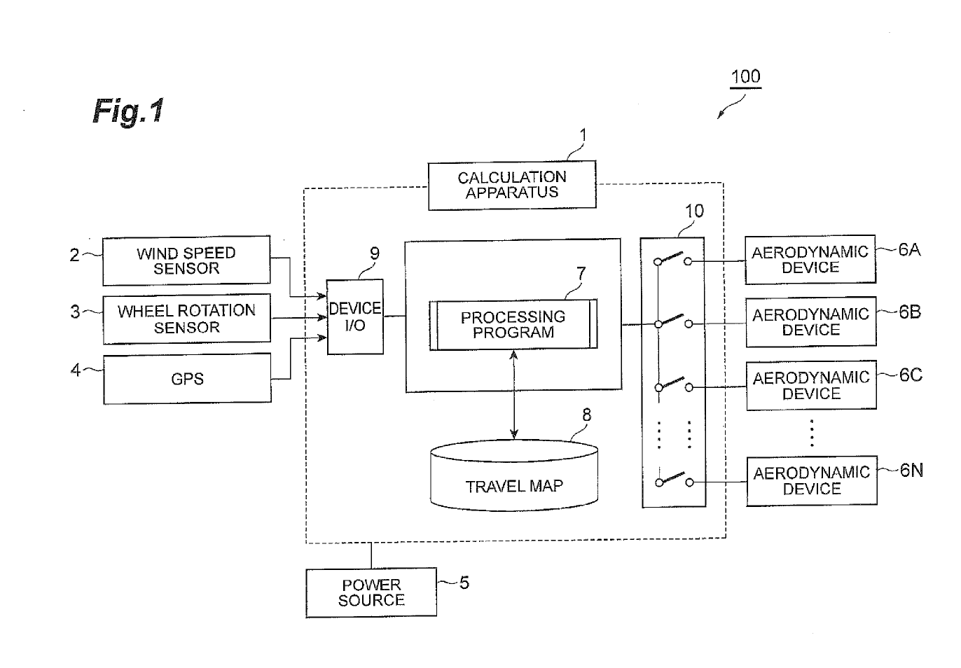

An example of a travel assistance apparatus and a travel assistance method in an embodiment of the present invention will be described with reference to the drawings. As illustrated in FIG. 1, a travel assistance apparatus 100 in the present embodiment is mounted on a vehicle, and assists the traveling of the vehicle such that the vehicle can stably travel straight against an airflow around the vehicle such as a crosswind. The travel assistance apparatus 100 includes a calculation apparatus 1, a wind speed sensor 2, a wheel rotation sensor 3, a GPS 4, a power source 5, aerodynamic devices 6A to 6N, a processing program 7, a travel map 8, a device I/O 9, and a device switch 10.

Specifically, the calculation apparatus 1 is configured as a computer that includes a central processing unit (CPU), a read only memory (ROM), and a random access memory (RAM). The calculation apparatus 1 operates in real time. A calculation apparatus 1 having an operation period in which the calculation can be performed faster than the sum of a program processing time and the operation time of the aerodynamic devices 6A to 6N is used.

The wind speed sensor 2 obtains a ground speed of the vehicle by detecting wind pressure. The detection of the wind pressure can be performed using an ultrasonic wave, a strain gauge, a change in temperature due to wind pressure such as a heat wire, a pitot tube and a barometer.

The wheel rotation sensor 3 obtains the ground speed of the vehicle by detecting a rotation speed of the vehicle wheels.

The global positioning system (GPS) 4 acquires position information and the ground speed of the vehicle using a GPS satellite. As long as the position information of the vehicle can be obtained, a device that performs a three-point positioning by receiving waves at the mobile station from three base stations or a device that performs the positioning by image recognition can be applied instead of the GPS 4.

The power source 5 supplies power to the travel assistance apparatus 100.

The aerodynamic devices 6A to 6N are devices that can change the forces in each axis direction of front and rear, left and right, and up and down direction of the vehicle and a 6-component force characteristic value relating to a moment around each axis. The aerodynamic devices 6A to 6N are specifically a front spoiler, a rear spoiler, a front wing, and a rear wing. The aerodynamic devices 6A to 6N can operate alone or in plural.

The calculation apparatus 1 includes a processing program 7, a travel map 8, a device I/O 9, and a device switch 10. The processing program 7 causes the calculation apparatus 1 to execute processing described below.

The travel map 8 has a function of reading information about a region where the vehicle is travelling from the media such as a non-volatile memory, a power back-up memory, a hard disk drive (HDD), a DVD-ROM, and a CD-ROM.

Besides the information on the road shape, the information relating to the airflow (crosswind) predicted for each region is the information included in the travel map 8. For example, a region where there is no airflow such as in a tunnel is recorded as a windless region in the travel map 8. In addition, a region where a strong crosswind occurs such as on a bridge outside the tunnel, on an elevated road, or on the street with tall-building is recorded as a wind occurrence region in the travel map 8. The information on the airflow for each of these regions may be a statistical value in association with the season, the month, and the day in a year and in association with the time slot in a day.

Aerodynamic characteristic values relating to the forces normally received by the vehicle from the airflow in each of the windless regions and the wind occurrence region are recorded in the travel map 8 as a steady map. In addition, in the travel map 8, aerodynamic characteristic values relating to the forces transiently received by the vehicle from the airflow when the vehicle enters the wind occurrence region from the windless region and when the vehicle enters the windless region from the wind occurrence region, are recorded in the travel map 8 as an unsteady map. The steady map and the unsteady map are recorded in a state of operating any of the aerodynamic devices 6A to 6N.

The device I/O 9 and the device switch 10 connect the calculation apparatus 1 and the wind speed sensor 2 to the aerodynamic devices 6A to 6N outside the calculation apparatus 1. The devices may operate mechanically or electrically.

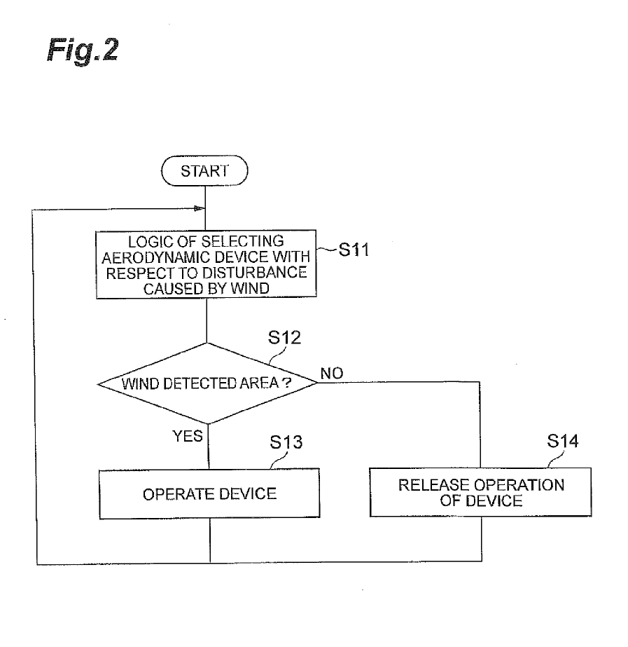

Hereinafter, an operation of the travel assistance apparatus 100 in the present embodiment will be described. As illustrated in FIG. 2, the calculation apparatus 1 executes the logic of selecting the aerodynamic devices 6A to 6N with respect to the disturbance caused by the airflow (S11). Airspeed is obtained from the wind speed sensor 2 in real time. The ground speed during travelling is obtained from the wheel rotation sensor 3 in real time. The ground speed and the position are obtained from the GPS 4 in real time. The calculation apparatus 1 refers to above information items and the information items in the travel map 8. In this way, the travelling area in the route in which the vehicle is currently travelling or will be travelling in the future is specified. The processing program 7 executes the processing based on the specified travelling area.

When the vehicle enters a wind detected area where the wind is detected (S12), the calculation apparatus 1 operates the aerodynamic devices 6A to 6N (S13). When the vehicle comes out from the wind detected area where the wind is detected (S12), the calculation apparatus 1 releases the operation of the aerodynamic devices 6A to 6N (S14).

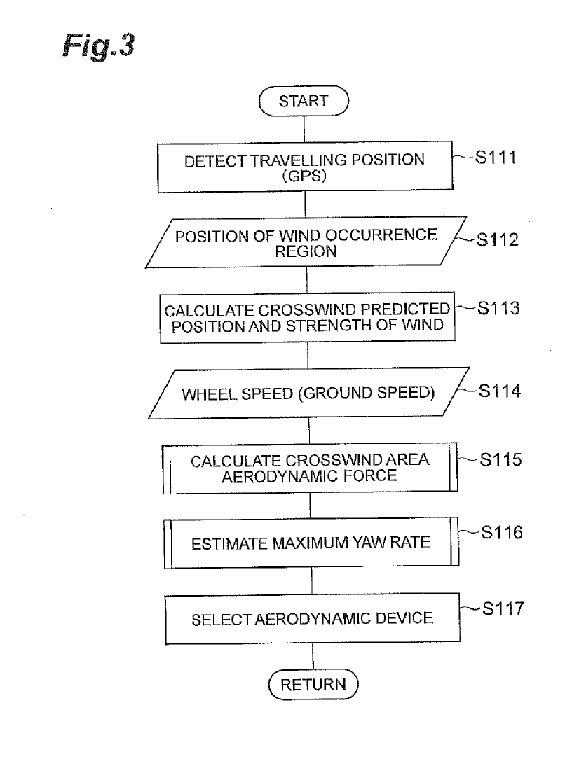

Hereinafter, the logic of selecting the aerodynamic devices 6A to 6N with respect to the disturbance caused by the airflow will be described in detail. As illustrated in FIG. 3, the calculation apparatus 1 detects the travelling position of the vehicle from the GPS 4 (S111). The calculation apparatus 1 reads out the information on the wind occurrence region or the airflow on the route on which the vehicle is predicted to travel from the travel map 8 (S112).

The calculation apparatus 1 calculates the crosswind predicted position on the route on which the travelling of the vehicle is predicted, and the strength of the airflow on the route on which the travelling of the vehicle is predicted, using the information read out from the travel map 8 (S113). The calculation apparatus 1 acquires the ground speed of the vehicle from the wheel rotation sensor 3 (S114). The calculation apparatus 1 calculates a force (crosswind area aerodynamic force) received by the vehicle from the airflow in the crosswind predicted area (wind occurrence region) (S115). The details of this calculation will be described below.

The processing program 7 estimates a maximum yaw rate at the time when the vehicle enters the wind occurrence region such as on a bridge outside the tunnel from the windless region such as in the tunnel and when the vehicle enters the windless region such as in the tunnel from the wind occurrence region such as on the bridge outside the tunnel (S116). The calculation apparatus 1 selects the aerodynamic devices 6A to 6N based on the estimated maximum yaw rate, and operates the selected aerodynamic devices 6A to 6N according to the travelling point of the vehicle (S117).

Hereinafter, a method of calculating the force received by the vehicle from the airflow at the time when the vehicle enters the wind occurrence region from the windless region and when the vehicle enters the windless region from the wind occurrence region will be described.

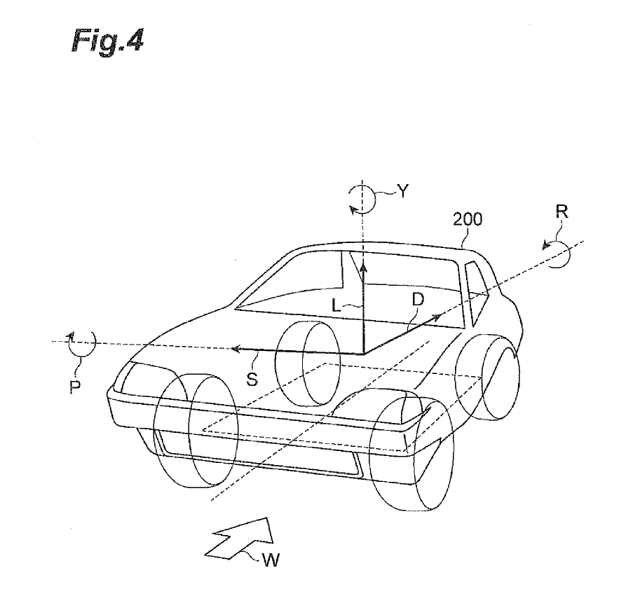

As illustrated in FIG. 4, in the forces acting on a vehicle 200 by an airflow w, there are: a drag force D which is parallel to the rear and front direction (front and rear axis (X axis) direction) of the vehicle 200 and in which the force from the front to the rear is positive, a lateral force S which is parallel to the lateral direction (right and left axis (Y axis) direction) of the vehicle 200 and in which the force from the left to the right is positive, and a lift force L which is parallel to the up and down direction (up and down axis (Z axis) direction) of the vehicle 200 and in which the upward force from below is positive (sometimes hereinafter, the drag force D, the lateral force S, and the lift force L will be referred to as three component forces). In addition, in the forces acting on the vehicle 200 caused by the airflow w, there are: a rolling moment R around the front and rear axis of the vehicle 200, a pitching moment P around the right and left axis of the vehicle 200 and a yawing moment Y around the up and down axis of the vehicle 200 (sometimes hereinafter, the rolling moment R, the pitching moment P, and the yawing moment Y will be referred to as three component force moments). Sometimes, as the dimensionless aerodynamic characteristic values of the forces acting on the vehicle 200 caused by the airflow w are referred to as a drag force coefficient C_{D}, a lateral force coefficient C_{S}, a lift force coefficient C_{L}, a rolling moment coefficient Cᵣ, a pitching moment coefficient Cₚ, and a yawing moment coefficient C_{y}, respectively.

As described above, a method of stabilizing the behavior during the travelling of the vehicle 200 in response to such the airflow w is proposed. However, the aerodynamic characteristic value which is a base of such a control is, for example, the yawing moment coefficient C_{y} in a steady state in the wind occurrence region. Therefore, it is not possible to cope with transient behavior between the steady state of a windless state such as in a tunnel and a steady state of a strong-wind state such as on a bridge outside the tunnel. That is because the transient phenomena such as a detachment, a reattachment, or a vortex of the airflow w to or from the vehicle 200 are not considered.

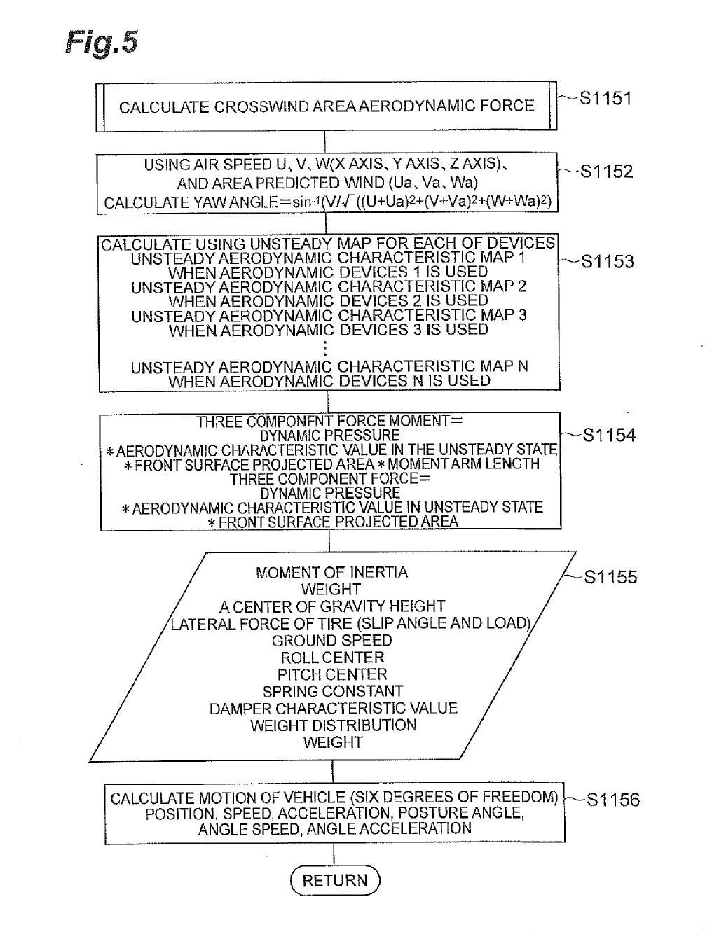

Therefore, in the present embodiment, aerodynamic force in the crosswind area is calculated with taking the transient phenomena by the airflow w into consideration. As illustrated in FIG. 5, in the calculation of the aerodynamic force in the crosswind area (S1151), the calculation apparatus 1 calculates a yaw angle θ of the vehicle 200 using the air speed obtained by the wind speed sensor 2 and each directional component of the airflow w at the region obtained from the travel map 8 (S1152). With the airspeed U, V, W (X axis, Y axis, and Z axis), each directional component at the area (Ua, Va, and Wa), the yaw angle θ is calculated as follows (S1152).

yaw angle θ=sin⁻¹ [V/{(U+Ua)²+(V+Va)²+(W+Wa)²}^{1/2}]

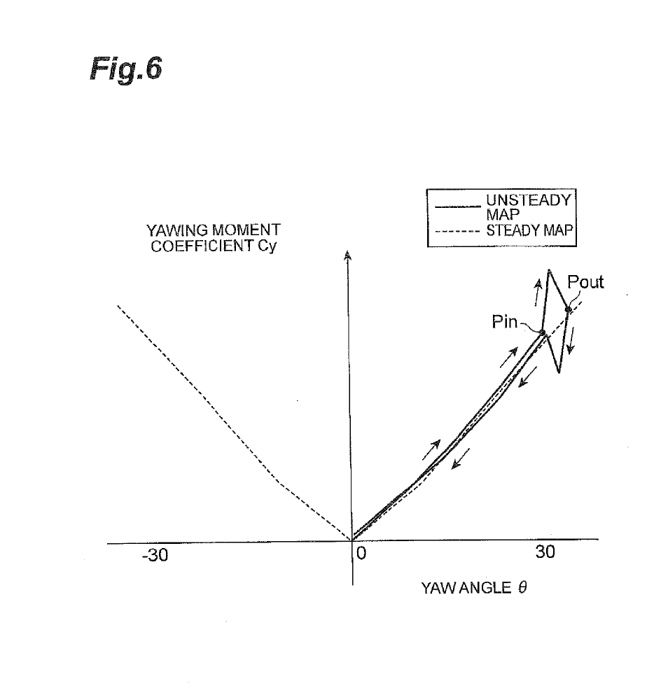

The calculation apparatus 1 predicts the aerodynamic force in the transient crosswind area for each of the aerodynamic devices 6A to 6N using the steady map and the unsteady map recorded in the travel map 8. Here, the description will be made using the yawing moment coefficient C_{y} as an example. As illustrated in FIG. 6, the yawing moment coefficient Cy with respect to the yaw angle θ for each point is recorded in the travel map 8.

In the values in the steady map illustrated by a dashed line in the drawing, the yaw angle θ and the yawing moment coefficient C_{y} are substantially proportional to each other. On the other hand, in the unsteady map illustrated by a solid line in the drawing, at an entrance Pᵢₙ to the wind occurrence region such as on the bridge from the windless region such as in the tunnel, the yawing moment coefficient C_{y} sharply increases with respect to the yaw angle θ because the front portions of the vehicle 200 receive a sudden crosswind. In addition, at an exit Pₒᵤₜ from the wind occurrence region such as on the bridge to the windless region such as in the tunnel, the yawing moment coefficient Cy sharply decreases with respect to the yaw angle θ because the crosswind to the front portion of the vehicle 200 sharply decreases compared to the crosswind to the rear portion.

Here, the yawing moment coefficient C_{y} at the entrance Pᵢₙ is taken into consideration. The function of the yawing moment coefficient Cy with respect to the yaw angle θ in the steady state is assumed to be “steady map f (yaw angle θ)”. The function of the yawing moment coefficient Cy with respect to the yaw angle θ in the unsteady state is assumed to be “unsteady map f (yaw angle θ)”.

When assuming the ratio of “unsteady map f (yaw angle θ)” to the “steady map f (yaw angle θ)” is “correction map f (relative position P)”, the yawing moment coefficient Cy at the entrance Pᵢₙ can be calculated as a multiplication of the “steady map f (yaw angle θ)” and the “correction map f (relative position P)”. Here, the relative position P in the “correction map f (relative position P)” is the relative position of the vehicle 200 with respect to the entrance Pᵢₙ. The value of the “correction map f (relative position P) (“unsteady map f (yaw angle θ)”) differs depending on the relative position P. Therefore, the value of the “correction map f (relative position P) is recorded in the travel map 8 depending on the relative position P.

The relative position P can be calculated by the multiplication of an elapsed time from the time when the vehicle 200 arrives at the entrance Pᵢₙ by the speed v of the vehicle 200. The calculation apparatus 1 performs the calculation for each predetermined period. The period of the calculation is determined by a reset signal. Therefore, the time t can be calculated by the multiplication of the integral value (counted value) of the reset signal by the calculation period.

As described above, the summary of formula for calculating the yawing moment coefficient C_{y} at the entrance Pᵢₙ is as follows. That is similar to the formula for calculating the yawing moment coefficient C_{y} at the entrance Pₒᵤₜ. In addition, other aerodynamic characteristic values such as the drag force coefficient C_{D}, the lateral force coefficient C_{S}, the lift force coefficient C_{L}, the rolling moment coefficient Cᵣ, and the pitching moment coefficient Cₚ also can similarly be calculated.

yawing moment coefficient C_{y}=correction map f (relative position P)×steady map f (yaw angle θ)

relative position P=time t×speed v

time t=integral value of reset signal×calculation period

Each of the unsteady map and the correction map when the aerodynamic devices 6A to 6N are respectively used is recorded in the travel map 8 in the situation similar to that described above. As illustrated in FIG. 5, the calculation apparatus 1 calculates the aerodynamic characteristic value when the aerodynamic characteristic value are respectively used using the unsteady map and the correction map for each of the aerodynamic devices 6A to 6N (S1153).

The calculation apparatus 1 calculates the three component force moments and the three component forces regarding each of the aerodynamic characteristic values actually acting on the vehicle 200 in the unsteady state obtained as described above (S1154).

Three component force moment=dynamic pressure of airflow×aerodynamic characteristic value in unsteady state×front surface projected area×moment arm length

Three component force=dynamic pressure of airflow×aerodynamic characteristic value in unsteady state×front surface projected area

The calculation apparatus 1 inputs a moment of inertia, a weight, a center of gravity height, a lateral force on a tire (slip angle and load), the ground speed, a roll center, a pitch center, a spring constant, a damper characteristic value, and a weight distribution and the weight of the vehicle 200 (S1155). The calculation apparatus 1 calculates the motion of the vehicle 200 having six degrees of freedom such as the position, the speed, acceleration, a posture angle, an angle speed, and angle acceleration (S1156).

In the present embodiment, in the travel assistance apparatus 100 configured to include the aerodynamic devices 6A to 6N that perform the travel assistance for stabilizing the behavior of the vehicle 200 and the calculation apparatus 1 configured to control the aerodynamic devices 6A to 6N in response to the disturbance to the behavior of the vehicle caused by the airflow w around the vehicle 200, the calculation apparatus 1 controls a travel assistance unit by an amount of operation varying in response to the disturbance. In addition, the calculation apparatus 1 controls the aerodynamic devices 6A to 6N in response to the disturbance in the unsteady state in which the disturbance is unsteady between the two steady states in which the disturbances caused by the airflow w are steady.

Therefore, for example, even in a case where the vehicle 200 moves from the region where there is no crosswind such as in the tunnel to the region where there is the crosswind such as outside the tunnel and thereby the strength of the airflow w around the vehicle suddenly changes, and thus, the disturbance of the force in the lateral direction of the vehicle and a yawing moment Y suddenly changes, the aerodynamic devices 6A to 6N are controlled in response to the transient disturbance in the unsteady state. Therefore, it is possible to improve the accuracy of control for stabilizing the behavior of the vehicle 200.

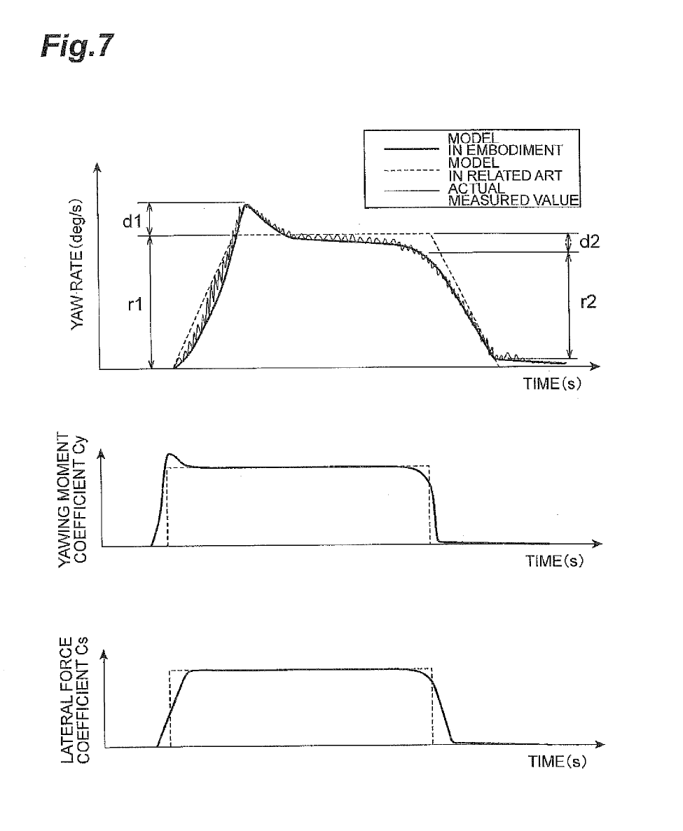

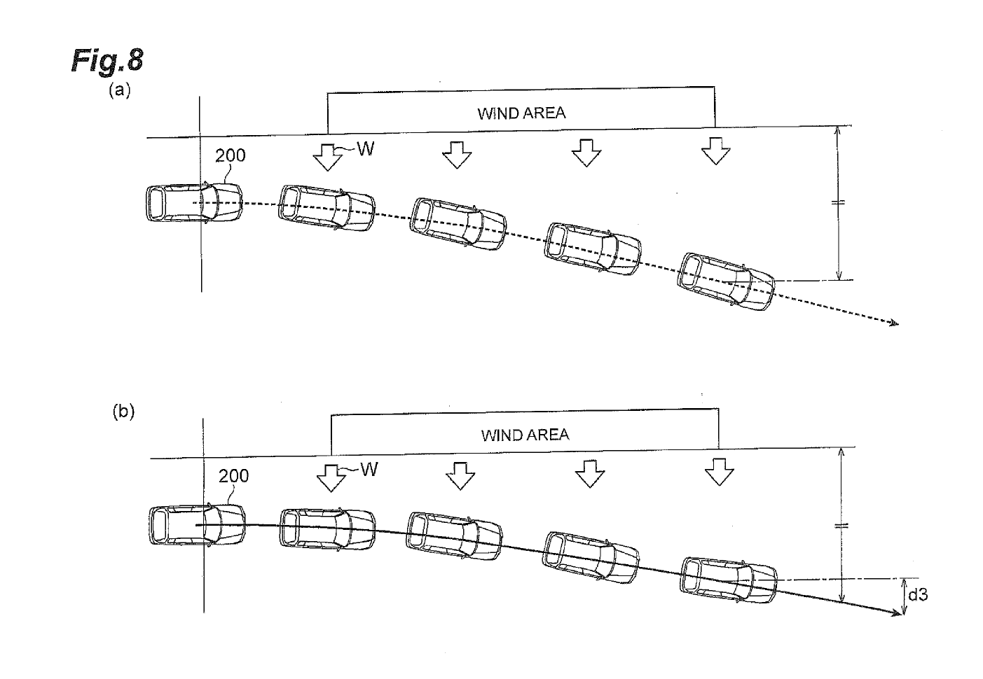

That is, as illustrated by a dashed line in FIG. 7, in the related art, the yaw rate, the yawing moment coefficient C_{y}, and the lateral force coefficient Cₛ are considered only with regard to the steady state. Therefore, in a transient state such as when the vehicle 200 moves from the region where there is no crosswind such as in the tunnel to the region where there is the crosswind such as outside the tunnel, or when the vehicle 200 moves from the region where there is crosswind such as outside the tunnel to the region where there is no crosswind such as in the tunnel, differences d1 and d2 between measured values of the yaw rate illustrated by the thin solid line in FIG. 7 are large, it is difficult to cope with the behavior of the actual vehicle 200. On the other hand, in the present embodiment, as illustrated by the thick solid line in FIG. 7, even in the transient state, values which are close to the measured values can be obtained, and thus, it is possible to easily cope with the behavior of the actual vehicle 200. Therefore, in the present embodiment, as illustrated in FIG. 8-(b), it is possible to decrease the lateral movement of the vehicle 200 caused by the airflow was much as the distance d3 compared to the method in the related art illustrated in FIG. 8-(a).

In addition, in the present embodiment, the calculation apparatus 1 predicts the disturbance in the unsteady state and controls the aerodynamic devices 6A to 6N in response to the predicted disturbance in the unsteady state. For this reason, for example, before the vehicle 200 moves from the region where there is no crosswind such as in the tunnel to the region where there is the crosswind such as outside the tunnel, it is possible to predict the sudden change of the disturbance caused by the airflow w. Therefore, it is possible to improve the responsiveness to the transient disturbance in the unsteady state.

In addition, in the present embodiment, the calculation apparatus 1 controls the aerodynamic devices 6A to 6N by the amount of operation that changes in response to the disturbance in the unsteady state. For this reason, it is possible to appropriately cope with the disturbance in the unsteady state compared to the control a constant amount of operation in the system in the related art. Therefore, it is possible to improve the accuracy of control for stabilizing the behavior of the vehicle 200.

In addition, according to the present embodiment, the calculation apparatus 1 controls the aerodynamic devices 6A to 6N in response to the disturbance in the unsteady state in which the vehicle 200 enters the strong wind region where the disturbance caused by the airflow w is greater than that in the weak wind region from the weak wind region where the disturbance caused by the airflow w is small and the disturbance in the unsteady state in which the vehicle 200 enters the weak wind region from the strong wind region. In this way, for example, it is possible to cope with the case where the vehicle 200 moves from the region where there is no crosswind such as in the tunnel to the region where there is a strong crosswind such as on a bridge outside the tunnel, or on the contrary, the case where the vehicle 200 moves from the region where there is a strong crosswind such as on the bridge to the region where there is no crosswind such as in the tunnel.

In addition, according to the present embodiment, a region where the disturbance caused by the airflow w from the lateral direction of the vehicle 200 is greater than that in the weak wind region is treated as the strong wind region. For this reason, the calculation apparatus 1 can cope with the case where the disturbance caused by the airflow w from the lateral direction of the vehicle 200 which influences the straight travelling of the vehicle 200. Therefore, it is possible to improve the accuracy of stabilizing the straight travelling of the vehicle 200.

In addition, in the present embodiment, a case where a first disturbance in the steady state is smaller than a next disturbance in the steady state is treated. In this way, for example, it is possible to cope with the disturbance in the unsteady state that is generated in a case where the vehicle 200 moves from the region where there is no crosswind such as in the tunnel to the region where there is the strong crosswind such as on the bridge outside the tunnel.

In addition, in the present embodiment, a case where the first disturbance in the steady state is greater than the next disturbance in the steady state is treated. In this way, for example, it is possible to cope with the disturbance in the unsteady state that is generated in a case where the vehicle 200 moves from the region where there is the strong crosswind such as on the bridge to the region where there is no crosswind such as in the tunnel.

In addition, in the present embodiment, the aerodynamic devices 6A to 6N execute the travel assistance for stabilizing the behavior of the vehicle 200 in the yaw direction, the pitch direction, and the roll direction. For this reason, it is possible to cope with the disturbance in the yaw direction, the pitch direction, and the roll direction of the vehicle 200 which are susceptible to being influenced by the airflow w. As described above, in the present embodiment, the calculation relating to the motion in the direction other than the yaw direction is executed. Depending on the changes in the environment around the vehicle 200, the change in the posture due to the change in the lift force L, or the change in the height between the vehicle body and the ground surface is generated. The calculation apparatus 1 can select the aerodynamic devices 6A to 6N which have the optimal characteristics for travelling with respect to the above-described changes.

In addition, according to the present embodiment, the aerodynamic devices 6A to 6N execute the travel assistance for stabilizing the behavior of the vehicle 200 in the yaw direction. Therefore, it is possible to cope with the disturbance in the yaw direction of the vehicle 200 which is easily affected by the airflow w and influences the straight travelling of the vehicle 200.

In addition, according to the present embodiment, the aerodynamic devices 6A to 6N execute the travel assistance for stabilizing the behavior of the vehicle 200 at the time of travelling straight. In this way, it is possible to cope with the situation in which the vehicle 200 travels straight ahead and the influence of the disturbance caused by the airflow w is large.

The present invention is not limited to the above-described embodiment, and various modifications can be made. For example, in the embodiment described above, the travel map 8 includes the steady map and the unsteady map, and the steady map or the unsteady map is selectively used according to the situation or the steady map is modified by the unsteady map. However, the travel assistance can be executed by configuring the travel map 8 to include only the unsteady map and by changing a condition of starting the travel assistance determined by a predetermined threshold value or the like using the unsteady map.

In addition, in the embodiment described above, the case where the vehicle 200 moves from the region where there is no crosswind such as in the tunnel to the region where there is the strong crosswind such as on the bridge outside the tunnel, and the case where the vehicle 200 moves from the region where there is the strong crosswind such as on the bridge to the region where there is no crosswind such as in the tunnel are exemplified as the case where the disturbance caused by the airflow is the unsteady state. However, for example, the above described embodiment can also be applied to a case where the host vehicle and another vehicle pass each other and then, the disturbance caused by the airflow is the unsteady state. In this case, it is preferable that the travel map 8 include the unsteady map or the correction map for the case of passing the other vehicle.

In addition, in the embodiment described above, as the travel assistance, the description is focused on the aspect in which the travel assistance apparatus 100 automatically operates the aerodynamic devices 6A to 6N. However, in the embodiment described above, it is also possible to assist the operation by the driver by increasing the steering torque based on the force caused by the airflow w in the unsteady state calculated by the calculation apparatus 1 or the yaw rate. In addition, in the embodiment described above, it is also possible to urge the driver to perform an operation for stabilizing the travelling of the vehicle 200 by an instruction using a voice or an image, or by a reaction force or a vibration with respect to a steering wheel or a pedal, based on the force caused by the airflow w in the unsteady state calculated by the calculation apparatus 1 or the yaw rate.

In addition, in the embodiment described above, as the travel assistance, the description is focused on the aspect in which the aerodynamic devices 6A to 6N are operated. However, in the embodiment described above, it is also possible to stabilize the travelling of the vehicle 200 by distributing or adjusting the braking force on each wheel based on the force caused by the airflow w in the unsteady state calculated by the calculation apparatus 1 or the yaw rate. Alternatively, it is also possible to perform both of the operation of the aerodynamic devices 6A to 6N and the distribution or adjustment of the braking force on each wheel.

In addition, in the embodiment described above, in the control of the aerodynamic devices 6A to 6N, the most suitable aerodynamic device may be selected from the plurality of aerodynamic devices 6A to 6N or the amount of operation of the single or plural aerodynamic devices among the plurality of aerodynamic devices 6A to 6N may be changed.

In addition, in the embodiment described above, in the travel assistance with respect to the airflow w, the travel assistance may be executed or prepared before the change of the airflow w. As the preparation for the travel assistance, for example, it can be considered that the state of the aerodynamic devices 6A to 6N may be changed in advance such that the state of the aerodynamic devices 6A to 6N can be immediately changed to a certain state.

### INDUSTRIAL APPLICABILITY

According to a travel assistance apparatus and a travel assistance method in an embodiment of the present invention, it is possible to improve the accuracy of control for stabilizing a behavior of a vehicle.

### REFERENCE SIGNS LIST

1 calculation apparatus

2 wind speed sensor

3 wheel rotation sensor

4 GPS

5 power source

6A˜6N aerodynamic device

7 processing program

8 travel map

9 device I/O

10 device switch

100 travel assistance apparatus

200 vehicle

1-13. (canceled)

14. A travel assistance apparatus comprising:
a travel assistance unit configured to execute a travel assistance for stabilizing a behavior of a vehicle; and
a control unit configured to control the travel assistance unit in response to a disturbance to the behavior of the vehicle caused by an airflow around the vehicle,
wherein the control unit is configured to control the travel assistance unit by an amount of operation that varies in response to the disturbance,
wherein the control unit is configured to control the travel assistance unit in response to the disturbance in an unsteady state in which the disturbance is unsteady between a first steady state in which the disturbance caused by the airflow is steady and a second steady state in which the disturbance caused by the airflow is steady after the first steady state,
wherein the control unit is configured to predict the disturbance in the unsteady state and to control the travel assistance unit in response to the predicted disturbance in the unsteady state, and
wherein the control unit is configured to control the travel assistance unit by an amount of operation that varies in response to the disturbance in the unsteady state.

15. The travel assistance apparatus according to claim 14,
wherein the control unit is configured to control the travel assistance unit in response to at least any of the disturbance in the unsteady state when the vehicle enters a weak wind region where the disturbance caused by the airflow is small to a strong wind region where the disturbance caused by the airflow is greater than that in the weak wind region and the disturbance in the unsteady state when the vehicle enters from the strong wind region to the weak wind region.

16. The travel assistance apparatus according to claim 15,
wherein, in the strong wind region, the disturbance caused by the airflow from a lateral direction of the vehicle is greater than that in the weak wind region.

17. The travel assistance apparatus according to claim 14,
wherein the disturbance in the first steady state is smaller than the disturbance in the second steady state.

18. The travel assistance apparatus according to claim 14,
wherein the disturbance in the first steady state can be greater than the disturbance in the second steady state.

19. The travel assistance apparatus according to claim 14,
wherein the travel assistance unit is configured to execute the travel assistance for stabilizing the behavior of the vehicle in at least one of the yaw direction, the pitch direction, and the roll direction.

20. The travel assistance apparatus according to claim 19,
wherein the travel assistance unit is configured to execute the travel assistance for stabilizing the behavior of the vehicle in the yaw direction.

21. The travel assistance apparatus according to claim 14,
wherein the travel assistance unit is configured to execute the travel assistance for stabilizing the behavior of the vehicle when travelling straight.

22. A travel assistance method of controlling a travel assistance unit that executes a travel assistance for stabilizing a behavior of a vehicle in response to a disturbance to the behavior of the vehicle caused by an airflow around the vehicle,
wherein the travel assistance unit is controlled by an amount of operation that varies in response to the disturbance,
wherein the travel assistance unit is controlled in response to the disturbance in an unsteady state in which the disturbance is unsteady between a first steady state in which the disturbance caused by the airflow is steady and a second steady state in which the disturbance caused by the airflow is steady after the first steady state,
wherein the control unit is configured to predict the disturbance in the unsteady state and to control the travel assistance unit in response to the predicted disturbance in the unsteady state, and
wherein the control unit is configured to control the travel assistance unit by an amount of operation that varies in response to the disturbance in the unsteady state.
